(19) United States
(12) Patent Application Publication
(10) Pub. No.: US 2025/0118088 A1
(43) Pub. Date: Apr. 10, 2025

(54) TRAFFIC LIGHT PREDICTION METHOD, ELECTRONIC DEVICE AND STORAGE MEDIUM

(71) Applicant: Beijing Baidu Netcom Science Technology Co., Ltd., Beijing (CN)

(72) Inventors: Weixin LU, Beijing (CN); Wei LIU, Beijing (CN); Guowei WAN, Beijing (CN); Zhenguang ZHU, Beijing (CN)

(21) Appl. No.: 18/980,156

(22) Filed: Dec. 13, 2024

(30) Foreign Application Priority Data
Dec. 19, 2023 (CN) 202311754128.2

(51) Int. Cl. G06V 20/58; G06V 10/764; G06V 10/77; G06V 10/82; G06V 20/56

(52) U.S. Cl. CPC G06V 20/584; G06V 10/764; G06V 10/7715; G06V 10/82; G06V 20/588

(57) ABSTRACT

A traffic light prediction method, an apparatus, and an autonomous vehicle are provided. The method includes determining lane line information of a lane where the vehicle is located and information of a target traffic light corresponding to the lane based on current position information of the vehicle, and recording the lane line formation and the information of the target traffic light as element information; recognizing an obstacle in the image acquired by the vehicle to obtain obstacle information; and associating element information with obstacle information to generate topology information, where the topology information is used to represent a binding relationship among a target traffic light, a lane line, and an obstacle; and generating a prediction result of the target traffic light based on the element information, the obstacle information, and the topology information.

### CROSS-REFERENCE TO RELATED APPLICATIONS

This application claims the priority from Chinese Patent Application No. 202311754128.2, filed on Dec. 19, 2023, and titled “TRAFFIC LIGHT PREDICTION METHOD, DEVICE, AND AUTONOMOUS VEHICLE,” the entire disclosure of which is hereby incorporated by reference.

### TECHNICAL FIELD

The present disclosure relates to the field of artificial intelligence, and more particularly, to the field of autonomous driving, intelligent traffic, and deep learning, and more particularly, to a traffic light prediction method, an electronic device and a storage medium.

### BACKGROUND

In autonomous driving solutions, traffic light recognition has always been a relatively important aspect, as it determines the driving status of autonomous vehicles at intersections and plays a crucial role in the safety of driverless vehicles.

### SUMMARY

The present disclosure provides a traffic light prediction method, apparatus, and autonomous vehicle.

According to a first aspect of the present disclosure, there is provided a traffic light prediction method, including: determining lane line information of a lane where a vehicle is located and information of a target traffic light corresponding to the lane, based on current position information of the vehicle, and recording the lane line formation and the information of the target traffic light as element information; recognizing an obstacle in the image acquired by the vehicle to obtain obstacle information; associating element information with obstacle information to generate topology information, where the topology information is used to represent a binding relationship among a target traffic light, a lane line, and an obstacle; and generating a prediction result of the target traffic light based on the element information, the obstacle information, and the topology information.

According to a second aspect of the present disclosure, there is provided an electronic device including at least one processor; and a memory in communication with the at least one processor; where the memory stores instructions executable by the at least one processor, the instructions being executed by the at least one processor to enable the at least one processor to perform the method as described in any of the implementations of the first aspect.

According to a third aspect of the present disclosure, there is provided a non-transitory computer readable storage medium storing computer instructions for causing a computer to perform a method as described in any of the implementations of the first aspect.

It should be understood that the content described in this section is not intended to identify key or important features of the embodiments disclosed herein, nor is it intended to limit the scope of the disclosure. The other features disclosed herein will be easily understood through the following description.

### BRIEF DESCRIPTION OF THE DRAWINGS

The drawings are for a better understanding of the present solution and do not constitute a limitation of the present disclosure. Here:

FIG. 1 is an exemplary system architecture diagram in which the present disclosure may be applied;

FIG. 2 is a flowchart of an embodiment of a traffic light prediction method according to the present disclosure;

FIG. 3 is a flowchart of another embodiment of a traffic light prediction method according to the present disclosure;

FIG. 4 is a flowchart of yet another embodiment of a traffic light prediction method according to the present disclosure;

FIG. 5 is a flowchart of yet another embodiment of a traffic light prediction method according to the present disclosure;

FIG. 6 is an application scenario diagram of a traffic light prediction method according to the present disclosure;

FIG. 7 is a schematic structural diagram of an embodiment of a traffic light prediction apparatus according to the present disclosure;

FIG. 8 is a block diagram of an electronic device for implementing a traffic light prediction method according to an embodiment of the present disclosure.

### DETAILED DESCRIPTION OF EMBODIMENTS

The following description of exemplary embodiments of the present disclosure, taken in conjunction with the accompanying drawings, includes various details of embodiments of the present disclosure to facilitate understanding, and is to be considered as exemplary only. Accordingly, one of ordinary skill in the art will recognize that various changes and modifications may be made to the embodiments described herein without departing from the scope and spirit of the disclosure. Also, for clarity and conciseness, descriptions of well-known functions and structures are omitted from the following description.

Generally speaking, traffic light recognition involves two key processes: first, traffic light detection and color recognition; second, associating the traffic light recognition results with the driving status of autonomous vehicles and even social vehicles. Existing strategies mainly rely on map topology annotation and rule constraints, but they tend to fail at complex intersections. Moreover, there is currently no particularly satisfactory solution to the problem of traffic light occlusion caused by obstacles.

It is noted that the embodiments in the present disclosure and the features in the embodiments may be combined with each other without conflict. The present disclosure will now be described in detail with reference to the accompanying drawings and examples.

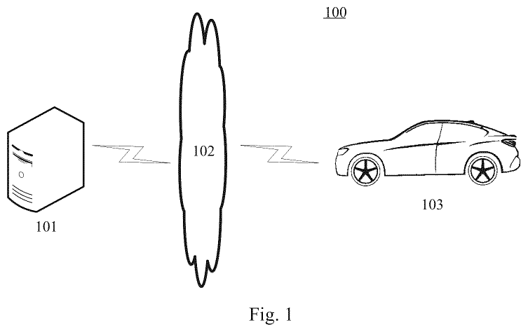

FIG. 1 illustrates an exemplary system architecture 100 to which an embodiment of a traffic light prediction method or traffic light prediction apparatus of the present disclosure may be applied.

As shown in FIG. 1, the system architecture 100 may include a server 101, a network 102, and an autonomous vehicle 103. The network 102 serves as a medium for providing a communication link between the server 101 and the autonomous vehicle 103. Network 102 may include various types of connections, such as wired, wireless communication links, or fiber optic cables, among others.

The server 101 may provide various services. For example, the server 101 may analyze and process the current position information and the acquired image acquired from the autonomous vehicle 103, generate a processing result (for example, a prediction result of a target traffic light), and transmit the processing result to the autonomous vehicle 103.

The autonomous vehicle 103 may interact with the server 101 through the network 102 to receive or send messages or the like. For example, the autonomous vehicle 103 may acquire current position information and an acquired image, and transmit the acquired information and the acquired image to the server 101.

It should be noted that the traffic light prediction method provided in the embodiments of the present disclosure is generally performed by the autonomous vehicle 103, and accordingly, the traffic light prediction apparatus is generally provided in the autonomous vehicle 103.

It should be understood that the number of autonomous vehicles, networks, and servers in FIG. 1 is merely illustrative. There may be any number of terminal devices, networks, and servers as desired for implementation.

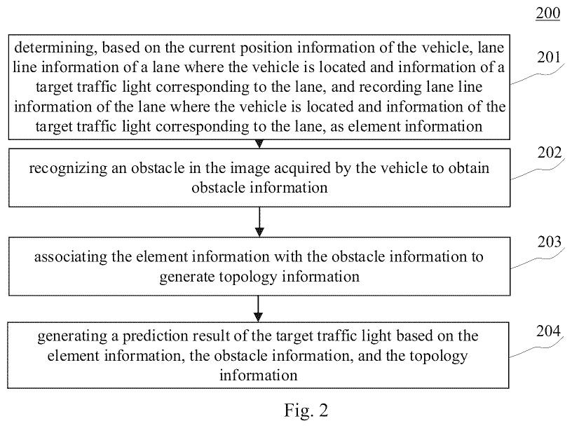

With continuing reference to FIG. 2, a flow diagram 200 of an embodiment of a traffic light prediction method according to the present disclosure is shown. The traffic light prediction method includes following steps.

Step 201 includes: determining, based on the current position information of the vehicle, lane line information of a lane where the vehicle is located and information of a target traffic light corresponding to the lane, and recording lane line information of the lane where the vehicle is located and information of the target traffic light corresponding to the lane, as element information.

In the present embodiment, the execution body of the traffic light prediction method (for example, the autonomous vehicle 103 shown in FIG. 1) acquires the current position information of the vehicle, determines the lane line information of the lane where the vehicle is located and the information of the target traffic light corresponding to the lane based on the current position information of the vehicle, and records the lane line formation and the information of the target traffic light as element information. The vehicle may be an autonomous vehicle or a vehicle with an autonomous driving mode. The aforementioned executing entity may obtain the current location information of the vehicle through vehicle-mounted sensors installed on the autonomous vehicle, such as the Global Positioning System (GPS).

Then, the execution body determines lane line information of a lane in which the vehicle is currently located based on the current position information. For example, the execution body acquires lane line information corresponding to the current position of the vehicle from a pre-constructed high-precision map. Lane lines, which are markings on the road surface, are road signs used to indicate vehicle driving directions and divide roads, effectively improving road use efficiency and safety. Lane lines here may include: road centerlines, road edge lines, road dividing lines, stop lines, pedestrian crossings, etc. The information of lane lines includes attribute information of lane lines, such as solid or dashed, color, and so on.

After the lane line where the vehicle is located determined, the execution body may further determine the information of the target traffic light corresponding to the lane. Since the lane lines on each lane should correspond to the traffic lights at an intersection, generally speaking, the traffic lights from left to right and from top to bottom correspond to the lanes from left to right respectively. Once the lane line of the lane where the vehicle is located is determined, the corresponding target traffic light for that lane can be identified. Subsequently, the information of the target traffic light is obtained, such as historical timing information of the target traffic light.

Finally, the execution body records the lane line information and the information of the target traffic light as the element information.

Step 202 includes recognizing an obstacle in the image acquired by the vehicle to obtain obstacle information.

In the present embodiment, the execution body acquires the image acquired by the vehicle while acquiring the current position information of the vehicle, and recognizes an obstacle in the image acquired by the vehicle to obtain obstacle information. The execution body acquires an image acquired by an image sensor mounted on an autonomous vehicle, that is, a sensor for acquiring an image, typically a 2D (2-dimension, two-dimensional) sensor, such as a camera sensor. After the acquired image is acquired, the execution body recognizes an obstacle in the image, thereby obtaining obstacle information. Here, the execution body detects and recognizes an obstacle in an image by using an image detection method or a point cloud detection method, thereby obtaining category information of the obstacle, such as a pedestrian, a vehicle, or a bicycle. Then, the execution entity also tracks the detected obstacles to obtain observation results of the obstacles at several historical moments.

Step 203 includes: associating the element information with the obstacle information to generate topology information.

In the present embodiment, the execution body associates the element information with the obstacle information to generate topology information, which is used to represent the binding relationship among the target traffic light, the lane line, and the obstacle. That is, the execution body correlates the lane line information, the information of the target traffic light, and the obstacle information, thereby generating a topological relationship for characterizing the binding relationship among the lane line, the target traffic light, and the obstacle. Specifically, an obstacle such as a pedestrian or a bicycle follows a corresponding roadside traffic light according to its orientation. Based on this, the execution body determines the corresponding roadside traffic light based on the category of the obstacle and the historical timing information of the obstacle, and acquires the historical timing information of the roadside traffic light. The roadside traffic light and the target traffic light are then associated to generate a binding relationship between the target traffic light and the lane line, thereby obtaining a topological relationship.

Step 204 includes: generating a prediction result of the target traffic light based on the element information, the obstacle information, and the topology information.

In the present embodiment, the execution body generates a prediction result of the target traffic light based on the element information, the obstacle information, and the topology information. Specifically, the execution body encodes the element information, the obstacle information, and the topology information by using the element information, the obstacle information, and the encoder corresponding to the topology information, respectively, that is, encodes the element information by using the element encoder to obtain an element encoding result; encodes the obstacle information by using the obstacle encoder to obtain an obstacle encoding result; and encodes the topology information by using the topology encoder to obtain a topology encoding result. The data of different sources are converted into the uniform feature space through the data encoding, and the different feature data are interacted in the uniform feature space, so that the feature is additionally corrected to obtain a better expression effect. Finally, a prediction result of the target traffic light is generated based on the element coding result, the obstacle coding result, and the topology coding result, and the prediction result includes color information (red, yellow, green, black) and status information of the target traffic light, and the status information includes a shape of the traffic light and whether the traffic light flashes or not.

A traffic light prediction method according to an embodiment of the present disclosure first determines lane line information of a lane where the vehicle is located and information of a target traffic light corresponding to the lane, based on current position information of the vehicle, and records the lane line formation and the information of the target traffic light as element information; then recognizes an obstacle in the image acquired by the vehicle to obtain obstacle information; then associates element information with obstacle information to generate topology information; and finally generates a prediction result of the target traffic light based on the element information, the obstacle information and the topology information. According to the traffic light prediction method of the present embodiment, the target traffic light corresponding to the traffic light is first determined according to the current position of the vehicle, and then information of the target traffic light is predicted according to lane line information of a lane where the vehicle is currently located and information of an obstacle around the vehicle, thereby improving accuracy of traffic light prediction.

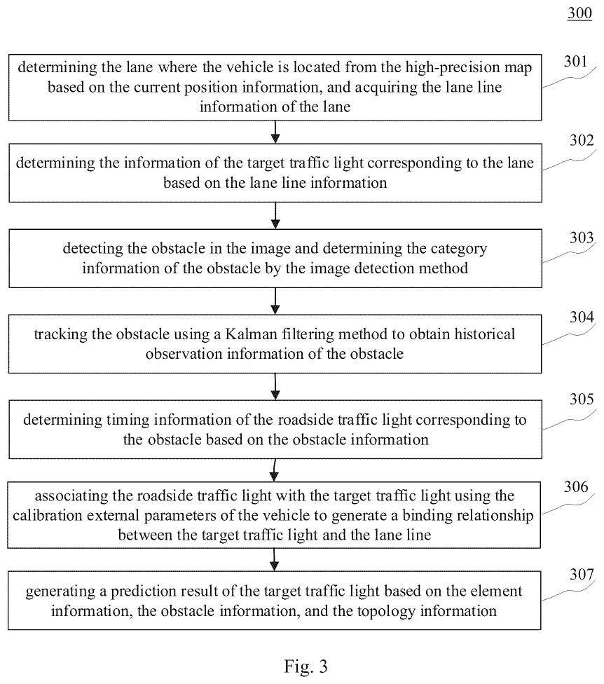

With continuing reference to FIG. 3, a flow diagram 300 of another embodiment of a traffic light prediction method according to the present disclosure is shown. The traffic light prediction method includes the following steps.

Step 301 includes: determining the lane where the vehicle is located from the high-precision map based on the current position information, and acquiring the lane line information of the lane.

In the present embodiment, the execution body of the traffic light prediction method (for example, the autonomous vehicle 103 shown in FIG. 1) determines the lane where the vehicle is located from the high-precision map based on the current position information, and acquires the lane line information of the lane. First, the execution body may acquire current position information of a vehicle, such as a Global Positioning System (GPS), by using an on-board sensor mounted on the autonomous vehicle. Then, the execution body determines lane line information of a lane where the vehicle is currently located based on the current position information. For example, the execution body acquires lane line information corresponding to the current position of the vehicle from a pre-constructed high-precision map. Lane lines here may include: road centerlines, road edge lines, road dividing lines, stop lines, pedestrian crossings, etc. The lane line information includes attribute information of lane lines, such as a solid line, a dashed line, a color, and the like.

Step 302 includes: determining the information of the target traffic light corresponding to the lane based on the lane line information.

In this embodiment, the execution body determines information of the target traffic light corresponding to the lane based on the lane line information. The execution body determines the information of the target traffic light corresponding to the lane. That is, the lane line on each lane should correspond to the traffic light at an intersection. Generally speaking, the traffic lights from left to right and from top to bottom correspond to the lanes from left to right respectively. Once the lane line where the vehicle is located is determined, the corresponding target traffic light for that lane can be identified. Subsequently, the information of the target traffic light, such as the historical timing information of the target traffic light, is acquired.

Step 303 includes detecting the obstacle in the image and determining the category information of the obstacle by the image detection method.

In the present embodiment, the execution body detects an obstacle in an image by using an image detection method or a point cloud detection method, and determines category information of the obstacle, such as a pedestrian, a vehicle, and a bicycle, for example, detects the obstacle by using an BEVDet frame.

Step 304 includes tracking the obstacle using a Kalman filtering method to obtain historical observation information of the obstacle.

In the present embodiment, the execution body tracks the obstacle by using the Kalman filtering method to obtain historical observation information of the obstacle. Kalman Filtering (Kalman filtering) is an algorithm that optimally estimates the state of a system by using linear system state equations and observing data through the system input and output. Since the effects of noise and interference in the system are included in the observation data, the optimal estimation may also be considered as a filtering process. The execution body tracks an obstacle by using a Kalman filtering method, thereby obtaining timing information of the obstacle at multiple historical moments. Here, the trace failure frame is filled with a zero element, thereby ensuring a correspondence relationship.

The execution body may collectively refer to the category information of the obstacle and the historical observation information of the obstacle as obstacle information.

Through the steps, obstacles in an image can be accurately detected and tracked.

Step 305 includes: determining timing information of the roadside traffic light corresponding to the obstacle based on the obstacle information.

In this embodiment, the execution body determines timing information of a roadside traffic light corresponding to an obstacle based on the obstacle information. Since an obstacle such as a pedestrian or a bicycle follows a corresponding roadside traffic light according to its orientation, the execution body determines the corresponding roadside traffic light based on the category of the obstacle and the historical timing information of the obstacle, and acquires the historical timing information of the roadside traffic light, including data such as the color and shape of the roadside traffic light. The state of the target traffic light is thus predicted based on the information of the roadside traffic light.

Step 306 includes associating the roadside traffic light with the target traffic light using the calibration external parameters of the vehicle to generate a binding relationship between the target traffic light and the lane line.

In this embodiment, the execution body associates the roadside traffic light with the target traffic light by using the calibration external parameters of the vehicle to generate the binding relationship between the target traffic light and the lane line. The calibration of the external parameters of the vehicle is related to the installation position of the sensor, and the position and the posture of the sensor in the body coordinate system are acquired through various prior information. Here, the execution body associates the traffic light (target traffic light) in the high-precision map with the result of the traffic light (roadside traffic light) recognized in the image, that is, the target traffic light is associated with the roadside traffic light, so that the binding relationship between the target traffic light and the lane line and the binding relationship between different lanes are generated based on the historical observation data of the obstacle, thereby obtaining the road topology relationship.

Step 307 includes: generating a prediction result of the target traffic light based on the element information, the obstacle information, and the topology information.

In the present embodiment, the execution body generates a prediction result of the target traffic light based on the element information, the obstacle information, and the topology information. Step 307 is substantially consistent with step 204 of the foregoing embodiment. For a specific implementation, reference may be made to the foregoing description of step 204, and details are not described herein.

As can be seen from FIG. 3, compared with the embodiment corresponding to FIG. 2, the traffic light prediction method of the present embodiment first determines lane line information of a lane where the vehicle is currently located from a high-precision map, and then recognizes an obstacle in an image, thereby determining category information and timing information of an obstacle, and also determines information of a roadside traffic light based on the obstacle information, and generates topology information based on the information, and finally determines a prediction result of a target traffic light, thereby further improving accuracy of traffic light state prediction.

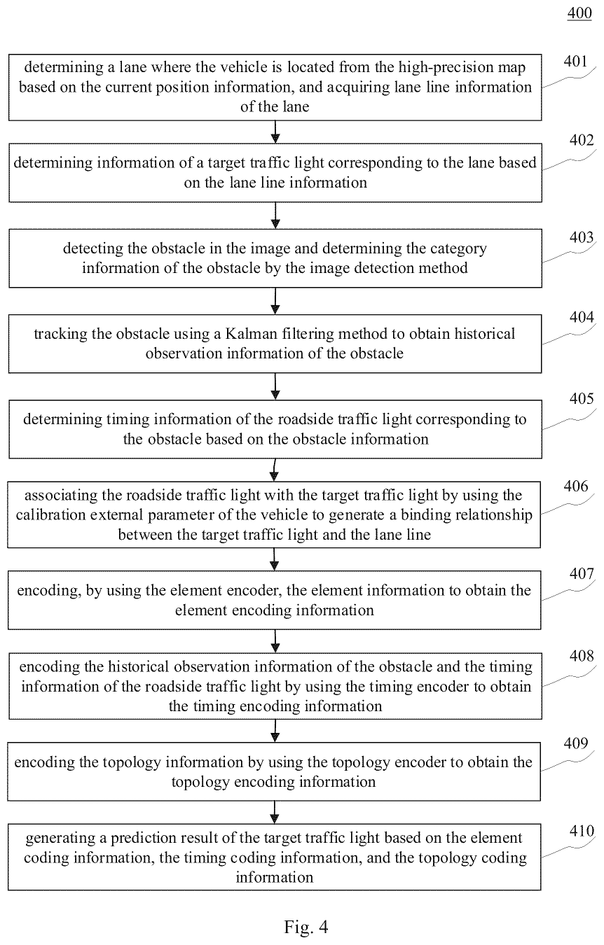

With continued reference to FIG. 4, a flow diagram 400 of yet another embodiment of a traffic light prediction method according to the present disclosure is shown. The traffic light prediction method includes the following steps.

Step 401 includes: determining a lane where the vehicle is located from the high-precision map based on the current position information, and acquiring lane line information of the lane.

Step 402 includes: determining information of a target traffic light corresponding to the lane based on the lane line information.

Step 403 includes: detecting the obstacle in the image and determining the category information of the obstacle by the image detection method.

Step 404 includes: tracking the obstacle using a Kalman filtering method to obtain historical observation information of the obstacle.

Step 405 includes: determining timing information of the roadside traffic light corresponding to the obstacle based on the obstacle information.

Step 406 includes: associating the roadside traffic light with the target traffic light by using the calibration external parameter of the vehicle to generate a binding relationship between the target traffic light and the lane line.

Step 401-406 is substantially consistent with step 301-306 of the foregoing embodiment. For a specific implementation, reference may be made to the foregoing description of step 301-306, and details are not described herein.

Step 407 includes: encoding, by using the element encoder, the element information to obtain the element encoding information.

In the present embodiment, the execution body of the traffic light prediction method (for example, the autonomous vehicle 103 shown in FIG. 1) encodes the element information by using the element encoder to obtain the element encoding information.

Step 408 includes: encoding the historical observation information of the obstacle and the timing information of the roadside traffic light by using the timing encoder to obtain the timing encoding information.

In the present embodiment, the execution body encodes the historical observation information of the obstacle and the timing information of the roadside traffic light by using the timing encoder, thereby obtaining the timing encoding information.

Step 409 includes encoding the topology information by using the topology encoder to obtain the topology encoding information.

In the present embodiment, the execution body encodes the topology information by using the topology encoder, thereby obtaining the topology encoding information.

Through various data encoding layers, the original data input into the network is encoded. The goal of encoding is to transform the original data originating from different data domains into a unified feature space, enabling them to interact and influence each other.

Step 410 includes: generating a prediction result of the target traffic light based on the element coding information, the timing coding information, and the topology coding information.

In the present embodiment, the execution body generates a prediction result of the target traffic light based on the element coding information, the timing coding information, and the topology coding information.

As can be seen from FIG. 4, compared with the embodiment corresponding to FIG. 3, the traffic light prediction method in the present embodiment highlights the steps of encoding different data by different encoders, and generating a prediction result of a target traffic light based on the encoded data, and converting original data originating from different data domains into a uniform feature space by encoding, so that the different data interact with each other, thereby more accurately predicting the state of the traffic light.

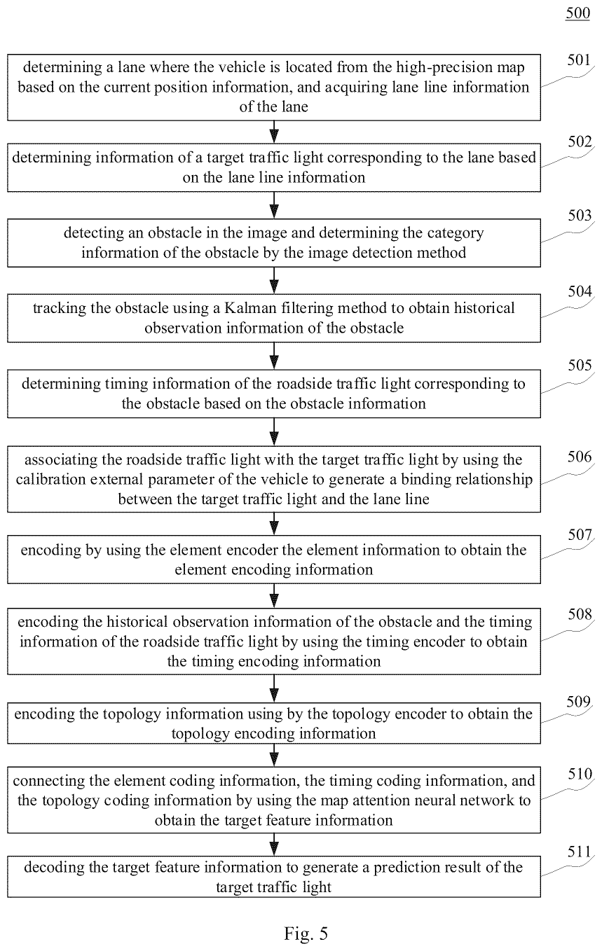

With continuing reference to FIG. 5, FIG. 5 illustrates a flow 500 of yet another embodiment of a traffic light prediction method according to the present disclosure. The traffic light prediction method includes the following steps.

Step 501 includes: determining a lane where the vehicle is located from the high-precision map based on the current position information, and acquiring lane line information of the lane.

Step 502 includes: determining information of a target traffic light corresponding to the lane based on the lane line information.

Step 503 includes: detecting an obstacle in the image and determining the category information of the obstacle by the image detection method.

Step 504 includes tracking the obstacle using a Kalman filtering method to obtain historical observation information of the obstacle.

Step 505 includes: determining timing information of the roadside traffic light corresponding to the obstacle based on the obstacle information.

Step 506 includes: associating the roadside traffic light with the target traffic light by using the calibration external parameter of the vehicle to generate a binding relationship between the target traffic light and the lane line.

Step 507 includes: encoding by using the element encoder the element information to obtain the element encoding information.

Step 508 includes encoding the historical observation information of the obstacle and the timing information of the roadside traffic light by using the timing encoder to obtain the timing encoding information.

Step 509 includes encoding the topology information using by the topology encoder to obtain the topology encoding information.

Step 501-509 is substantially consistent with step 401-409 of the foregoing embodiment. For a specific implementation, reference may be made to the foregoing description of step 401-409, and details are not described herein.

Step 510 includes: connecting the element coding information, the timing coding information, and the topology coding information by using the map attention neural network to obtain the target feature information.

In the present embodiment, the execution body of the traffic light prediction method (for example, the autonomous vehicle 103 shown in FIG. 1) connects the element coding information, the timing coding information, and the topology coding information by using the map attention neural network to obtain the target feature information. The attention network is a new neural network architecture based on graph structure data. The key mechanism of the attention neural network is the Attention mechanism, which allows the neural network to focus its “attention” on a portion of the input, i.e., it distinguishes the influence of different parts of the input on the output. The attention neural network belongs to the existing technology, and details are not described herein.

The execution body connects the element coding information, the timing coding information, and the topology coding information by using the map attention neural network to obtain the target feature information. The data of different sources is converted into a uniform feature space by data encoding, and different features are interacted in the feature space, so that the features from different elements are adsorbed to the stop line, and the features are additionally corrected to obtain a better expression effect.

Step 511 includes: decoding the target feature information to generate a prediction result of the target traffic light.

In this embodiment, the execution body decodes the target feature information to generate a prediction result of the target traffic light. By decoding the target feature information, the prediction effect of the traffic light, including the color (red, yellow, green and black) and the state (shape and whether flashing or not) of the target traffic light, is obtained.

As can be seen from FIG. 5, compared with the embodiment corresponding to FIG. 4, the traffic light prediction method in the present embodiment highlights the use of a map attention neural network to convert data from different sources into a uniform feature space, allowing different feature to interact in the feature space, and further supplementing and correcting features to obtain a better expression effect.

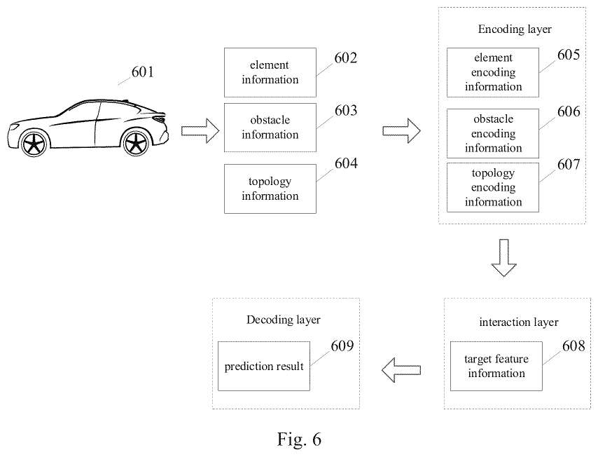

With further reference to FIG. 6, an application scenario of a traffic light prediction method according to the present disclosure is shown. In this application scenario, first, the execution body 601 (autonomous vehicle) determines the lane line information of the lane where the vehicle is located and the information of the target traffic light corresponding to the lane based on the current position information of the vehicle, and record the lane line formation and the information of the target traffic light as the element information 602. Then, the obstacle in the image acquired by the vehicle is recognized to obtain obstacle information 603. Thereafter, the element information is associated with the obstacle information to generate the topology information 604. Then, through the encoding layer, the corresponding encoding information is obtained, that is, the element information is encoded by the element encoder to obtain the element encoding information 605; the obstacle information is encoded by using the obstacle encoder to obtain obstacle encoding information 606; the topology information is encoded by using a topology encoder to obtain topology encoding information 607. Then, the element coding information, the obstacle coding information, and the topology coding information are connected by the map attention neural network through the interaction layer to obtain the target feature information 608. Finally, the target feature information is decoded through the decoding layer to generate the prediction result 609 of the target traffic light.

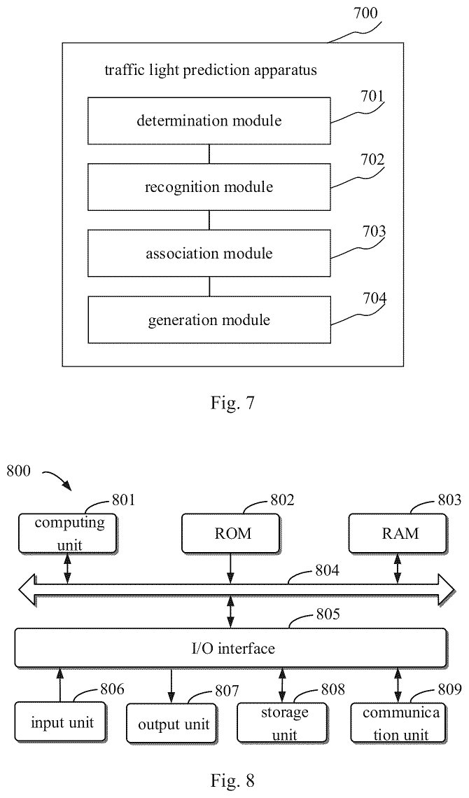

With further reference to FIG. 7, as an implementation of the method shown in the figures, the present disclosure provides an embodiment of a traffic light prediction apparatus which corresponds to the method embodiment shown in FIG. 2 and which is particularly applicable to various electronic devices.

As shown in FIG. 7, the traffic light prediction apparatus 700 of the present embodiment includes a first determination module 701, a recognition module 702, an association module 703, and a generation module 704. The first determining module 701 is configured to determine lane line information of a lane where the vehicle is located and information of a target traffic light corresponding to the lane based on the current position information of the vehicle, and record the lane line formation and the information of the target traffic light as element information; an recognition module 702 configured to recognize an obstacle in an image acquired by the vehicle to obtain obstacle information; an association module 703 configured to associate the element information with the obstacle information to generate topology information, where the topology information is used to represent a binding relationship among the target traffic light, the lane line, and the obstacle; and the generation module 704 is configured to generate a prediction result of the target traffic light based on the element information, the obstacle information, and the topology information.

In the present embodiment, the specific processing of the first determination module 701, the recognition module 702, the association module 703, and the generation module 704 and the technical effects thereof may be described with reference to the related description of step 201-204 in the corresponding embodiment in FIG. 2, and details are not described herein again.

In some alternative implementations of the present embodiment, the first determining module is further configured to determine a lane where the vehicle is located from the high-precision map based on the current position information, and acquire lane line information of the lane; and determine the information of the target traffic light corresponding to the lane based on the lane line information.

In some alternative implementations of the present embodiment, the obstacle information includes category information of the obstacle and historical observation information of the obstacle; and the recognition module is further configured to detect an obstacle in the and determine category information of the obstacle image by using the image detection method; and track the obstacle by using a Kalman filter method to obtain historical observation information of the obstacle.

In some alternative implementations of the present embodiment, the traffic light prediction apparatus 700 further includes a second determining module configured to determine timing information of a roadside traffic light corresponding to an obstacle based on the obstacle information; and the association module is further configured to associate the roadside traffic light with the target traffic light using the calibration external parameter of the vehicle to generate a binding relationship between the target traffic light and the lane line.

In some alternative implementations of the present embodiment, the generation module includes an element encoding submodule configured to encode the element information using the element encoder to obtain the element encoding information; a timing coding submodule configured to encode historical observation information of an obstacle and timing information of a roadside traffic light by using a timing encoder to obtain timing coding information; a topology coding submodule configured to encode topology information by using a topology encoder to obtain topology coding information; and a generation submodule configured to generate a prediction result of the target traffic light based on the element coding information, the timing coding information, and the topology coding information.

In some alternative implementations of the present embodiment, the generation submodule is further configured to connect the element coding information, the timing coding information, and the topology coding information by using the graph attention neural network to obtain the target feature information; and decode the target feature information to generate a prediction result of the target traffic light.

According to an embodiment of the present disclosure, the present disclosure also provides an electronic device, a readable storage medium, a computer program product, and an autonomous vehicle.

FIG. 8 illustrates a schematic block diagram of an example electronic device 800 that may be used to implement embodiments of the present disclosure. Electronic devices are intended to represent various forms of digital computers, such as laptop computers, desktop computers, worktables, personal digital assistants, servers, blade servers, mainframe computers, and other suitable computers. Electronic devices may also represent various forms of mobile devices, such as personal digital processing, cellular telephones, smart phones, wearable devices, and other similar computing devices. The components shown herein, their connections and relationships, and their functions are by way of example only and are not intended to limit the implementation of the disclosure described and/or claimed herein.

As shown in FIG. 8, the apparatus 800 includes a calculation unit 801, which may perform various appropriate actions and processes according to a computer program stored in a read-only memory (ROM) 802 or a computer program loaded into a random access memory (RAM) 803 from a storage unit 808. In RAM 803, various programs and data required for operation of the device 800 may also be stored. The calculation units 801, ROM 802 and RAM 803 are connected to each other via a bus 804. An input/output (I/O) interface 805 is also connected to bus 804.

A plurality of components in the device 800 are connected to the I/O interface 805, including an input unit 806, such as a keyboard, a mouse, and the like; an output unit 807, for example, various types of displays, speakers, and the like; a storage unit 808, such as a magnetic disk, an optical disk, or the like; and a communication unit 809, such as a network card, a modem, or a wireless communication transceiver. The communication unit 809 allows the device 800 to exchange information/data with other devices over a computer network such as the Internet and/or various telecommunications networks.

The computing unit 801 may be various general-purpose and/or special-purpose processing components having processing and computing capabilities. Some examples of computing units 801 include, but are not limited to, central processing units (CPUs), graphics processing units (GPUs), various specialized artificial intelligence (AI) computing chips, various computing units that run machine learning model algorithms, digital signal processors (DSPs), and any suitable processors, controllers, microcontrollers, and the like. The calculation unit 801 performs various methods and processes described above, such as a traffic light prediction method. For example, in some embodiments, the traffic light prediction method may be implemented as a computer software program tangibly embodied in a machine-readable medium, such as a storage unit 808. In some embodiments, some or all of the computer program may be loaded and/or installed on the device 800 via the ROM 802 and/or the communication unit 809. When the computer program is loaded into the RAM 803 and executed by the calculation unit 801, one or more steps of the traffic light prediction method described above may be performed. Alternatively, in other embodiments, the computing unit 801 may be configured to perform the traffic light prediction method by any other suitable means (e.g., by means of firmware).

The autonomous vehicle provided in the present disclosure may include the electronic device shown in FIG. 8, which, when executed by its processor, is capable of implementing the traffic light prediction method described in any of the embodiments.

The various embodiments of the systems and techniques described above herein may be implemented in a digital electronic circuit system, an integrated circuit system, a field programmable gate array (FPGA), an application specific integrated circuit (ASIC), a special purpose standard product (ASSP), a system on a system on a chip (SOC), a load programmable logic device (CPLD), computer hardware, firmware, software, and/or combinations thereof. These various embodiments may include being implemented in one or more computer programs that may execute and/or interpret on a programmable system including at least one programmable processor, which may be a dedicated or general purpose programmable processor, may receive data and instructions from a memory system, at least one input device, and at least one output device, and transmit the data and instructions to the memory system, the at least one input device, and the at least one output device.

The program code for performing the methods of the present disclosure may be written in any combination of one or more programming languages. These program codes may be provided to a processor or controller of a general purpose computer, special purpose computer, or other programmable data processing apparatus such that the program code, when executed by the processor or controller, causes the functions/operations specified in the flowchart and/or block diagram to be implemented. The program code may be executed entirely on the machine, partly on the machine, partly on the machine as a stand-alone software package and partly on the remote machine or entirely on the remote machine or server.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage media may include one or more line-based electrical connections, portable computer disks, hard disks, random access memory (RAM), read-only memory (ROM), erasable programmable read-only memory (EPROM or flash memory), optical fibers, portable compact disk read-only memory (CD-ROM), optical storage devices, magnetic storage devices, or any suitable combination of the foregoing.

To provide interaction with a user, the systems and techniques described herein may be implemented on a computer having a display device (e.g., a CRT (cathode ray tube) or LCD (liquid crystal display) monitor) for displaying information to the user; and a keyboard and a pointing device (e.g., a mouse or a trackball) through which a user can provide input to a computer. Other types of devices may also be used to provide interaction with a user. For example, the feedback provided to the user may be any form of sensory feedback (e.g., visual feedback, auditory feedback, or tactile feedback); and input from the user may be received in any form, including acoustic input, speech input, or tactile input.

The systems and techniques described herein may be implemented in a computing system including a background component (e.g., as a data server), or a computing system including a middleware component (e.g., an application server), or a computing system including a front-end component (e.g., a user computer having a graphical user interface or a web browser through which a user may interact with embodiments of the systems and techniques described herein), or a computing system including any combination of such background component, middleware component, or front-end component. The components of the system may be interconnected by any form or medium of digital data communication (e.g., a communication network). Examples of communication networks include a local area network (LAN), a wide area network (WAN), and the Internet.

The computer system may include a client and a server. The client and server are typically remote from each other and typically interact through a communication network. The relationship between the client and the server is generated by a computer program running on the corresponding computer and having a client-server relationship with each other. The server may be a cloud server, a server of a distributed system, or a server incorporating a chain of blocks.

It is to be understood that the steps of reordering, adding or deleting may be performed using the various forms shown above. For example, the steps described in the present disclosure may be performed in parallel or sequentially or in a different order, so long as the desired results of the technical solution disclosed in the present disclosure can be realized, and no limitation is imposed herein.

The foregoing detailed description is not intended to limit the scope of the present disclosure. It will be appreciated by those skilled in the art that various modifications, combinations, sub-combinations, and substitutions may be made depending on design requirements and other factors. Any modifications, equivalents, and modifications that fall within the spirit and principles of the disclosure are intended to be included within the scope of protection of the disclosure.

What is claimed is:

1. A traffic light prediction method, comprising:
determining, based on current position information of a vehicle, lane line information of a lane where the vehicle is located and information of a target traffic light corresponding to the lane, and recording the lane line formation and the information of the target traffic light as element information;
recognizing an obstacle in an image acquired by the vehicle to obtain obstacle information;
associating the element information with the obstacle information to generate topology information, wherein the topology information is used to characterize a binding relationship among the target traffic light, the lane line, and the obstacle; and
generating a prediction result of the target traffic light based on the element information, the obstacle information, and the topology information.

2. The method according to claim 1, wherein the determining the lane line information of the lane where the vehicle is located and information of the target traffic light corresponding to the lane based on the current position information of the vehicle comprises:
determining the lane where the vehicle is located from a high-precision map based on the current position information, and acquiring the lane line information of the lane; and
determining the information of the target traffic light corresponding to the lane based on the lane line information.

3. The method according to claim 2, wherein the obstacle information includes category information of the obstacle and historical observation information of the obstacle; and
recognizing the obstacle in the image acquired by the vehicle to obtain obstacle information includes:
detecting an obstacle in the image and determining the category information of the obstacle by using the image detection method; and
tracking the obstacle by using a Kalman filtering method to obtain the historical observation information of the obstacle.

4. The method according to claim 3, wherein
the method further comprises: determining timing information of a roadside traffic light corresponding to the obstacle based on the obstacle information; and
associating the element information with the obstacle information to generate the topology information includes: associating the roadside traffic light with the target traffic light by using a calibration external parameter of the vehicle to generate a binding relationship between the target traffic light and the lane line.

5. The method according to claim 4, wherein generating the prediction result of the target traffic light based on the element information, the obstacle information, and the topology information comprises:
encoding the element information by using an element encoder to obtain element encoding information;
encoding historical observation information of the obstacle and timing information of the roadside traffic light by using a timing encoder to obtain timing encoding information;
encoding the topology information by using a topology encoder to obtain topology encoding information; and
generating a prediction result of the target traffic light based on the element coding information, the timing coding information, and the topology coding information.

6. The method according to claim 5, wherein generating the prediction result of the target traffic light based on the element coding information, the timing coding information, and the topology coding information comprises:
connecting the element coding information, the timing coding information, and the topology coding information by using a map attention neural network to obtain target feature information; and
decoding the target feature information to generate the prediction result of the target traffic light.

7. An electronic device comprising:
at least one processor; and
a memory in communication with the at least one processor; wherein,
the memory stores instructions executable by the at least one processor to enable the at least one processor to perform operations comprising:
determining, based on current position information of a vehicle, lane line information of a lane where the vehicle is located and information of a target traffic light corresponding to the lane, and recording the lane line formation and the information of the target traffic light as element information;
recognizing an obstacle in an image acquired by the vehicle to obtain obstacle information;
associating the element information with the obstacle information to generate topology information, wherein the topology information is used to characterize a binding relationship among the target traffic light, the lane line, and the obstacle; and
generating a prediction result of the target traffic light based on the element information, the obstacle information, and the topology information.

8. The electronic device according to claim 7, wherein the determining the lane line information of the lane where the vehicle is located and information of the target traffic light corresponding to the lane based on the current position information of the vehicle comprises:
determining the lane where the vehicle is located from a high-precision map based on the current position information, and acquiring the lane line information of the lane; and
determining the information of the target traffic light corresponding to the lane based on the lane line information.

9. The electronic device according to claim 8, wherein the obstacle information includes category information of the obstacle and historical observation information of the obstacle; and
recognizing the obstacle in the image acquired by the vehicle to obtain obstacle information includes:
detecting an obstacle in the image and determining the category information of the obstacle by using an image detection method; and
tracking the obstacle by using a Kalman filtering method to obtain the historical observation information of the obstacle.

10. The electronic device according to claim 9, wherein the operations further comprise: determining timing information of a roadside traffic light corresponding to the obstacle based on the obstacle information; and
associating the element information with the obstacle information to generate the topology information comprises: associating the roadside traffic light with the target traffic light by using a calibration external parameter of the vehicle to generate a binding relationship between the target traffic light and the lane line.

11. The electronic device according to claim 10, wherein generating the prediction result of the target traffic light based on the element information, the obstacle information, and the topology information comprises:
encoding the element information by using an element encoder to obtain element encoding information;
encoding historical observation information of the obstacle and timing information of the roadside traffic light by using a timing encoder to obtain timing encoding information;
encoding the topology information by using a topology encoder to obtain topology encoding information; and
generating a prediction result of the target traffic light based on the element coding information, the timing coding information, and the topology coding information.

12. The electronic device according to claim 11, wherein generating the prediction result of the target traffic light based on the element coding information, the timing coding information, and the topology coding information comprises:
connecting the element coding information, the timing coding information, and the topology coding information by using a map attention neural network to obtain target feature information; and
decoding the target feature information to generate the prediction result of the target traffic light.

13. A non-transitory computer-readable storage medium storing computer instructions for causing a computer to perform operations comprising:
determining, based on current position information of a vehicle, lane line information of a lane where the vehicle is located and information of a target traffic light corresponding to the lane, and recording the lane line formation and the information of the target traffic light as element information;
recognizing an obstacle in an image acquired by the vehicle to obtain obstacle information;
associating the element information with the obstacle information to generate topology information, wherein the topology information is used to characterize a binding relationship among the target traffic light, the lane line, and the obstacle; and
generating a prediction result of the target traffic light based on the element information, the obstacle information, and the topology information.

14. The non-transitory computer-readable storage medium according to claim 13, wherein the determining the lane line information of the lane where the vehicle is located and information of the target traffic light corresponding to the lane based on the current position information of the vehicle comprises:
determining the lane where the vehicle is located from a high-precision map based on the current position information, and acquiring the lane line information of the lane; and
determining the information of the target traffic light corresponding to the lane based on the lane line information.

15. The non-transitory computer-readable storage medium according to claim 14, wherein the obstacle information includes category information of the obstacle and historical observation information of the obstacle; and
recognizing the obstacle in the image acquired by the vehicle to obtain obstacle information includes:
detecting an obstacle in the image and determining the category information of the obstacle by using an image detection method; and
tracking the obstacle by using a Kalman filtering method to obtain the historical observation information of the obstacle.

16. The non-transitory computer-readable storage medium according to claim 15, wherein
the operations further comprise: determining timing information of a roadside traffic light corresponding to the obstacle based on the obstacle information; and
associating the element information with the obstacle information to generate the topology information comprises: associating the roadside traffic light with the target traffic light by using a calibration external parameter of the vehicle to generate a binding relationship between the target traffic light and the lane line.

17. The non-transitory computer-readable storage medium according to claim 16, wherein generating the prediction result of the target traffic light based on the element information, the obstacle information, and the topology information comprises:
encoding the element information by using an element encoder to obtain element encoding information;
encoding historical observation information of the obstacle and timing information of the roadside traffic light by using a timing encoder to obtain timing encoding information;
encoding the topology information by using a topology encoder to obtain topology encoding information; and
generating a prediction result of the target traffic light based on the element coding information, the timing coding information, and the topology coding information.

18. The non-transitory computer-readable storage medium according to claim 17, wherein generating the prediction result of the target traffic light based on the element coding information, the timing coding information, and the topology coding information comprises:
connecting the element coding information, the timing coding information, and the topology coding information by using a map attention neural network to obtain target feature information; and
decoding the target feature information to generate the prediction result of the target traffic light.
